(19) United States
(12) Patent Application Publication
(10) Pub. No.: US 2013/0010248 A1
(43) Pub. Date: Jan. 10, 2013

(54) PIXEL ELECTRODE STRUCTURE

(75) Inventor: Chih-tsung Kang, Shenzhen (CN)

(73) Assignee: Shenzhen China Star Optoelectronics Technology Co., Ltd., Shenzhen (CN)

(21) Appl. No.: 13/379,381

(22) PCT Filed: Sep. 21, 2011
(86) PCT No.: PCT/CN11/79920

§ 371 Date: Dec. 20, 2011

(30) Foreign Application Priority Data
Jul. 7, 2011 (CN) 201110189624.9

(51) Int. Cl. G02F 1/1343

(52) U.S. Cl. 349/139

(57) ABSTRACT

The present invention provides a pixel electrode structure comprising: a trunk portion including a vertical trunk portion and a horizontal trunk portion which are intersected vertically; and branch portions disposed in four sub-pixel regions which are divided by the vertical trunk portion and the horizontal trunk portion, wherein the branch portions in each of the sub-pixel regions include bending branch portions, and each of the bending branch portions is composed of branch sections, and angles between each adjacent two of the branch sections and the horizontal trunk portion are different, and there are slits between the bending branch portions. The present invention can efficiently solve the problems of a color shifting defect and a low color shifting defects resulting from the constant angle between the branch portions and the horizontal trunk portion or the vertical trunk portion.

### FIELD OF THE INVENTION

The present invention relates to a field of a liquid crystal display (LCD) technology, and more particularly to a pixel electrode structure of an LCD apparatus.

### BACKGROUND OF THE INVENTION

LCD is one of popular flat displays. The LCD comprises substrates having electrodes for generating an electric field, such as pixel electrodes and common electrodes, and a liquid crystal (LC) layer disposed between the substrates. When a voltage is applied to the electrodes to generating the electric field across the LC layer, an orientation of LC molecules of the LC layer is determined by the electric field, thereby adjusting a polarization of a light emitted to the LC layer, allowing the LCD to display images.

At present, a technique called polymer stabilized vertical alignment (PSVA) has been developed. In this technique, monomers of a proper concentration are mixed a LC material, and the mixed LC material is uniformly oscillated. Subsequently, the mixed LC material is heated by a heater to achieve an isotropy state. When a temperature of the mixed LC material is lowered to room temperature, the monomers mixed in the LC material are reverted to a nematic state. Thereafter, the mixed LC material is dispensed into the LC cell, and the voltage is applied thereto. When applying the voltage to orient the LC molecules, the monomers can have a polymerization to form a polymer layer by irradiated by UV light or heated for stabilizing alignment.

Referring to FIG. 1, a schematic diagram showing a common pixel electrode of a normal PSVA type LCD is illustrated.

As shown in FIG. 1, the pixel electrode of the normal PSVA type LCD is designed as a “ [symbol] ” shaped structure and has a vertical trunk portion and a horizontal trunk portion. The vertical trunk portion and the horizontal trunk portion are called main-pixel, wherein the vertical trunk portion and the horizontal trunk portion are intersected vertically. That is, the vertical trunk portion and the horizontal trunk portion are vertical at the center thereof to each other. The area of the pixel electrode is divided into four pixel regions of same areas, namely so-called sub-pixels, by the vertical trunk portion and the horizontal trunk portion. Each sub-pixel further has a plurality of elongated branch portions, wherein angles between the elongated branch portions and the vertical trunk portion or the horizontal trunk portion are ±45° or ±135°, and there are slits between the branch portions. That is, the branch portions, the vertical trunk portion and the horizontal trunk portion are located on the same plane, so as to form the “ [symbol] ” shaped pixel electrode with a mirror symmetrical structure as shown in FIG. 1.

However, in the conventional “ [symbol] ” shaped pixel electrode structure, the angles between the branch portions and the horizontal trunk portion (or the vertical trunk portion) are identical, and there are some color shifting defects existing therein, hence deteriorating a transmittance of the panel.

### SUMMARY OF THE INVENTION

The present invention provides a pixel electrode structure to solve the technical problems of a color shifting defect and a low color shifting defects resulting from the constant angle between the branch portions and the horizontal trunk portion (or the vertical trunk portion).

To solve the above-mentioned technical problem, the present invention provides a pixel electrode structure, comprising: a trunk portion including a vertical trunk portion and a horizontal trunk portion which are intersected vertically; and a plurality of branch portions disposed in four sub-pixel regions which are divided by the vertical trunk portion and the horizontal trunk portion, wherein the branch portions in each of the sub-pixel regions include a plurality of bending branch portions, and each of the bending branch portions is composed of a plurality of branch sections, and angles between each adjacent two of the branch sections and the horizontal trunk portion are different, and there are slits between the bending branch portions.

Preferably, the angles between the branch sections of the bending branch portions and the horizontal trunk portion are gradually increased from the branch section, which is closest to an intersected center of the horizontal trunk portion and the vertical trunk portion, to the farthest branch section away the intersected center thereof, wherein the angles are gradually increased from 0° to 90°.

Preferably, the angles between the branch sections of the bending branch portions and the horizontal trunk portion are gradually decreased from the branch section, which is closest to the intersected center of the horizontal trunk portion and the vertical trunk portion, to the farthest branch section away the intersected center thereof, wherein the angles are gradually increased from 90° to 0°.

Preferably, the amount of the branch sections of each of the bending branch portions is infinite, and the bending branch portions have smooth curved structures.

Preferably, the angles between the branch sections of the bending branch portions and the horizontal trunk portion are alternately increased and decreased from the branch section, which is closest to the intersected center of the horizontal trunk portion and the vertical trunk portion, to the farthest branch section away the intersected center thereof.

Preferably, the amount of the branch sections of each of the bending branch portions is infinite, the bending branch portions have smooth wavy structures.

Preferably, the pixel electrode structure is applicable to a polymer stabilization vertical-alignment (PSVA) mode liquid crystal display (LCD) panel or a pattern vertical alignment (PVA) mode LCD panel.

With the use of the embodiments of the present invention, the beneficial effects are described as below. The present invention aims to alter the angles between the bending branch portions and the horizontal trunk portion in the pixel electrode structure, and the branch portions are designed as bending branch portions, smooth curves or smooth wavy structures, and the angles between the bending branch portions and the horizontal trunk portion are not only ±45° and ±135°. Each of the bending branch portions of the branch portions is composed of the plurality of branch sections, and the angles between the branch sections and the horizontal trunk portion are different. Thus, by means of the pixel electrode structure of the present invention, the problems of the lower transmittance and the color shifting defect can be improved.

### DESCRIPTION OF THE DRAWINGS

The structure and the technical means adopted by the present invention to achieve the above and other objects can be best understood by referring to the following detailed description of the preferred embodiments and the accompanying drawings. Obviously, the following drawings are merely shown for some embodiments of the present invention. For a person skilled in the art, other drawings can be obtained according these drawings without creative labor.

FIG. 1 is a schematic diagram showing a common pixel electrode of a normal PSVA type LCD;

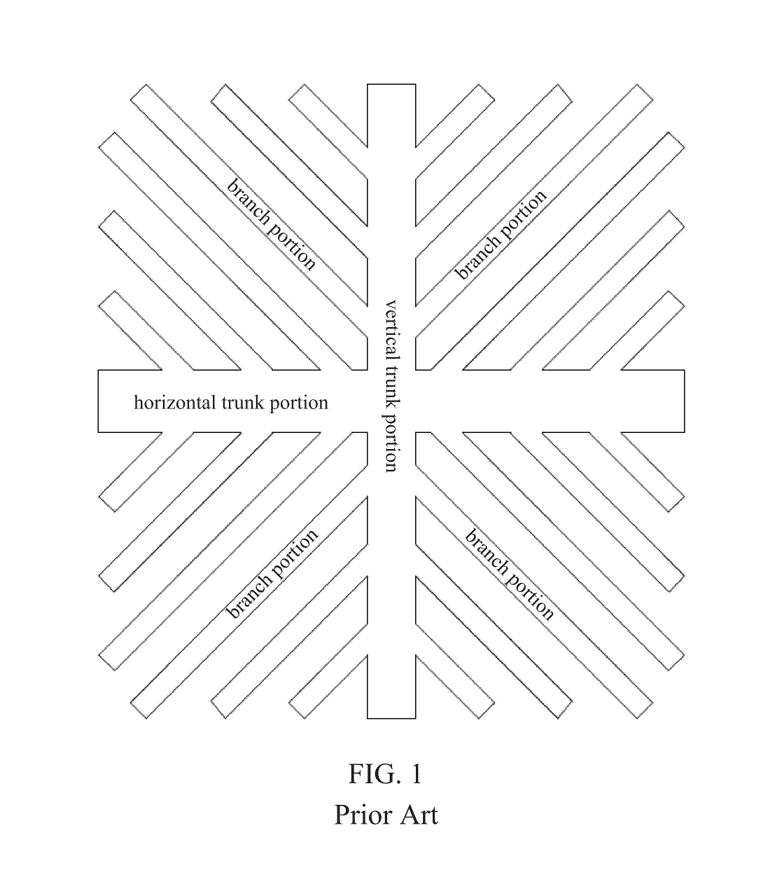

FIG. 2 is a structural diagram showing the pixel electrode structure according to a first embodiment of the present invention;

FIG. 3 is a structural diagram showing the pixel electrode structure according to a second embodiment of the present invention;

FIG. 4 is a structural diagram showing the pixel electrode structure according to a third embodiment of the present invention;

FIG. 5 is a structural diagram showing the pixel electrode structure according to a fourth embodiment of the present invention;

FIG. 6 is a structural diagram showing the pixel electrode structure according to a fifth embodiment of the present invention;

FIG. 7 is a structural diagram showing the pixel electrode structure according to a sixth embodiment of the present invention; and

FIG. 8 is a structural diagram showing the pixel electrode structure according to a seventh embodiment of the present invention.

### DETAILED DESCRIPTION OF THE PREFERRED EMBODIMENTS

The present invention provides a novel pixel electrode structure to solve the problem existing in the conventional pixel electrode structure which has a lower transmittance and a color shifting defect.

It should be explained that the present invention aims to alter the angles between the bending branch portions and the horizontal trunk portion in the pixel electrode structure, and the branch portions are designed as bending branch portions, smooth curves or smooth wavy structures, and the angles between the bending branch portions and the horizontal trunk portion are not only ±45° and ±135°.

Specifically, the pixel electrode structure of the embodiments of the present invention comprises: a trunk portion including a vertical trunk portion and a horizontal trunk portion which are intersected vertically; and a plurality of branch portions disposed in four sub-pixel regions which are divided by the vertical trunk portion and the horizontal trunk portion, wherein the branch portions in each of the sub-pixel regions include a plurality of bending branch portions, and each of the bending branch portions is composed of a plurality of branch sections, and angles between each adjacent two of the branch sections and the horizontal trunk portion are different, and there are slits between the bending branch portions.

The pixel electrode structure of the embodiments of the present invention comprises the branch portions, and each of the bending branch portions of the branch portions is composed of the plurality of branch sections, and the angles between the branch sections and the horizontal trunk portion are different. Thus, by means of the pixel electrode structure of the present invention, the problems of the lower transmittance and the color shifting defect can be improved.

The embodiments of the present invention can be best understood by referring to the following detailed description and the accompanying drawings.

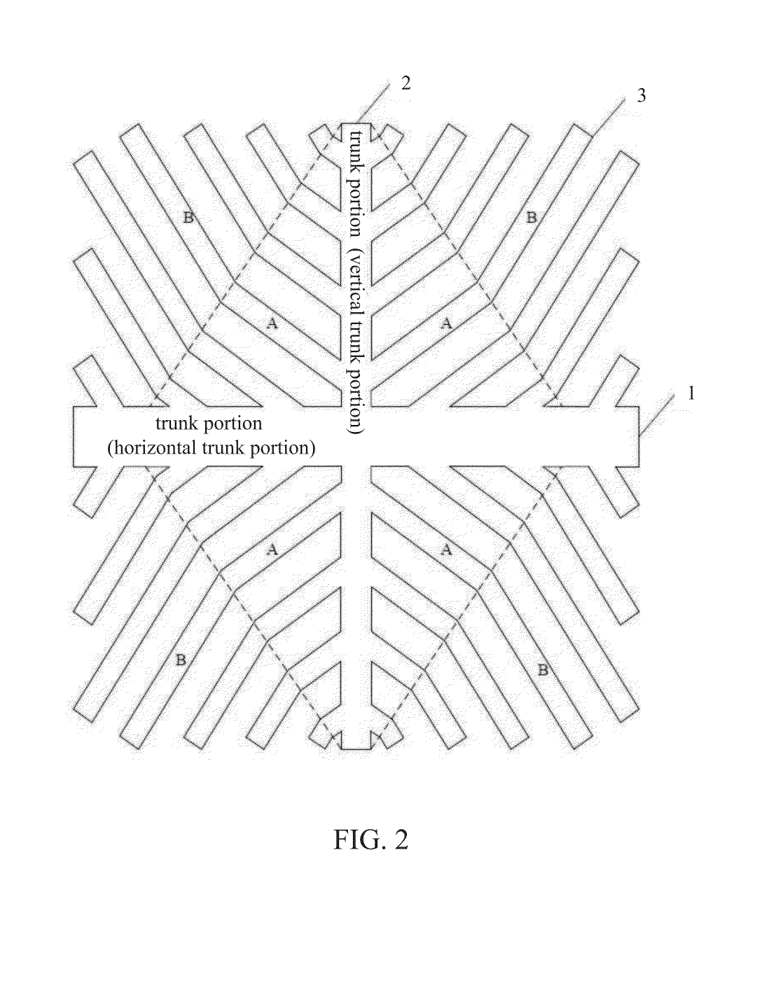

Referring to FIG. 2, FIG. 2 is a structural diagram showing the pixel electrode structure according to a first embodiment of the present invention.

The pixel electrode structure of this embodiment comprises a trunk portion and a plurality of branch portions. The trunk portion includes a horizontal trunk portion 1 and a vertical trunk portion 2. The horizontal trunk portion 1 and the vertical trunk portion 2 are intersected vertically at the center thereof to form a “ [symbol] ” shaped structure. The pixel electrode structure is divided into the four sub-pixel regions by the “ [symbol] ” shaped structure, and the electrodes disposed in the four sub-pixel regions are called the branch portions. The branch portions in each sub-pixel region includes a plurality of the bending branch portions 3, and each of the bending branch portions 3 is connected to the trunk portion, and there are the slits between the bending branch portions 3.

In this embodiment, each of the bending branch portions 3 has two angle designs. That is, each of the bending branch portions 3 can be composed of two branch sections, and the angles between the two branch sections and the horizontal trunk portion 1 are different. Certainly, the angles between the two branch sections and the vertical trunk portion 2 are also different. Specifically, as shown in FIG. 2, the bending branch portions 3 are composed of branch sections A and B. The angle between the branch sections A and the horizontal trunk portion 1 is different to the angle between the branch sections B and the horizontal trunk portion 1, and the angle between the branch sections A and the horizontal trunk portion 1 is less than the angle between the branch sections B and the horizontal trunk portion 1, so as to allow the bending branch portions 3 to have the bending structures.

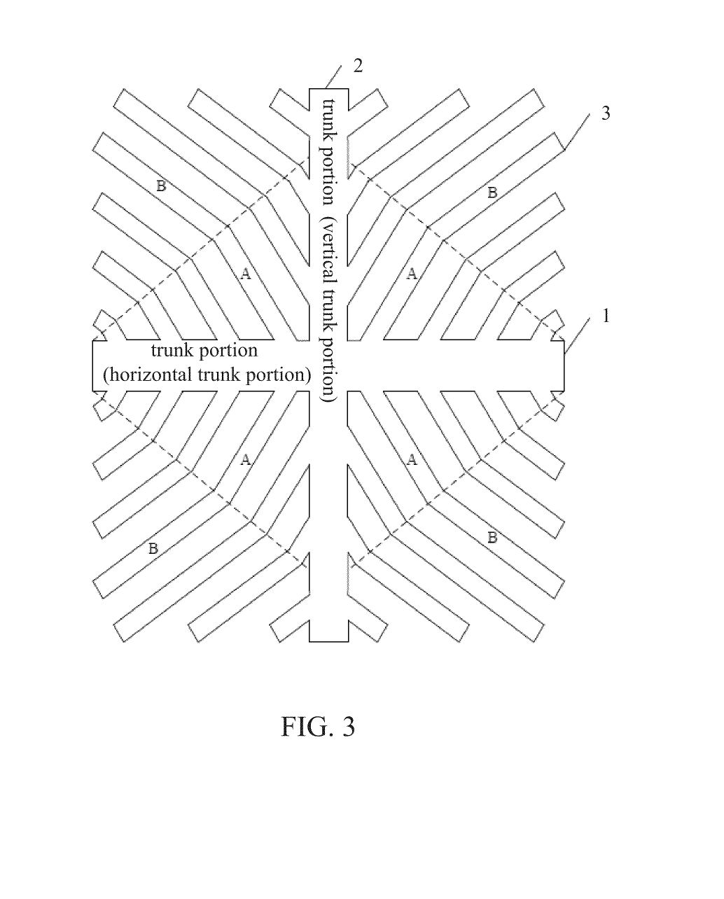

Referring to FIG. 3, FIG. 3 is a structural diagram showing the pixel electrode structure according to a second embodiment of the present invention.

In this embodiment, each of the bending branch portions 3 has two angle designs. Specifically, as shown in FIG. 3, the bending branch portions 3 are composed of branch sections A and B. The angle between the branch sections A and the horizontal trunk portion 1 is different to the angle between the branch sections B and the horizontal trunk portion 1, and the angle between the branch sections A and the horizontal trunk portion 1 is larger than the angle between the branch sections B and the horizontal trunk portion 1, so as to allow the bending branch portions 3 to have the bending structures.

The pixel electrode structures provide by the first embodiment and the second embodiment comprises the bending structures of the bending branch portions which are composes of the two branch sections, and the angles between the two branch sections and the horizontal trunk portion 1 are different. Certainly, according the principle of the present invention, each of the bending branch portions 3 of the branch portions can be composed of more branch sections, referring to the following embodiments.

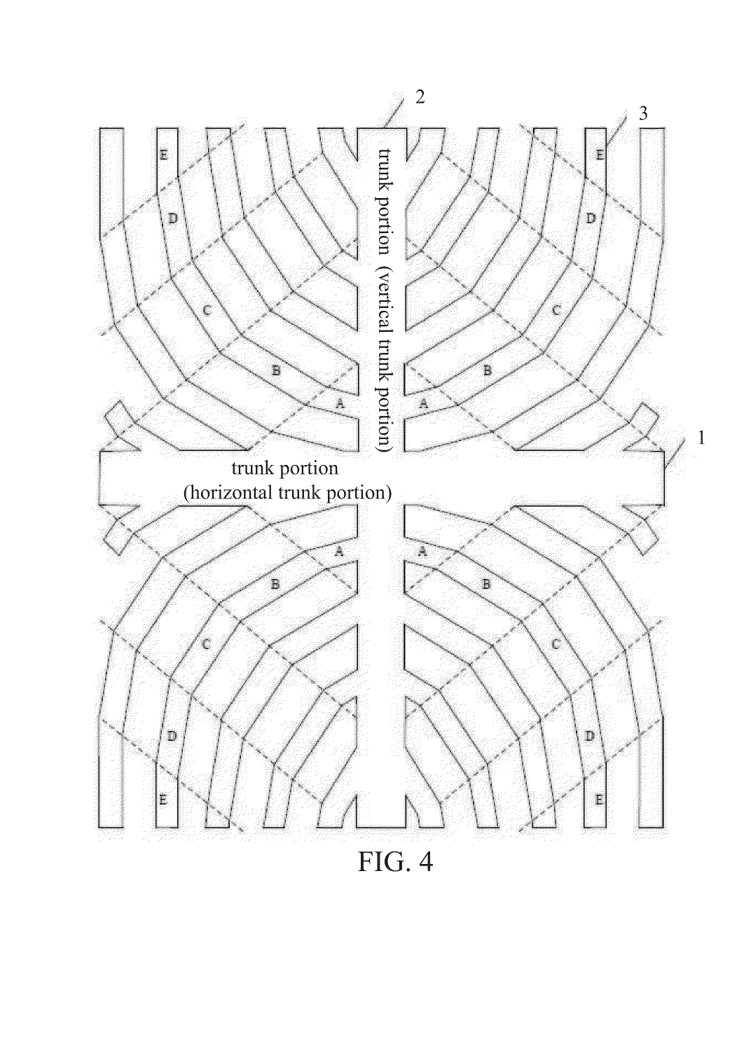

Referring to FIG. 4, FIG. 4 is a structural diagram showing the pixel electrode structure according to a third embodiment of the present invention.

In the pixel electrode structure of this embodiment of the present invention, the angles between the branch sections of the bending branch portions 3 and the horizontal trunk portion 1 are gradually increased from the branch section, which is closest to an intersected center of the horizontal trunk portion 1 and the vertical trunk portion 2, to the farthest branch section away the intersected center thereof.

Specifically, as shown in FIG. 4, the pixel electrode structure comprises the trunk portion and the plurality of branch portions. The trunk portion includes the horizontal trunk portion 1 and the vertical trunk portion 2. The horizontal trunk portion 1 and the vertical trunk portion 2 are intersected vertically at the center thereof to form a “ [symbol] ” shaped structure. The pixel electrode structure is divided into the four sub-pixel regions by the “ [symbol] ” shaped structure, and the electrodes disposed in the four sub-pixel regions are called the branch portions. The branch portions in each sub-pixel region includes a plurality of the bending branch portions 3, and each of the bending branch portions 3 is connected to the trunk portion, and there are the slits between the bending branch portions 3.

In this embodiment, each of the bending branch portions 3 has a plurality of angle designs. That is, each of the bending branch portions 3 can be composed of a plurality of branch sections, and the angles between the plurality of branch sections and the horizontal trunk portion 1 are different. Certainly, the angles between the plurality of branch sections and the vertical trunk portion 2 are also different. Specifically, as shown in FIG. 4, the bending branch portions 3 are composed of branch sections A, B, C, D and E. The angles between the plurality of branch sections A, B, C, D and E and the horizontal trunk portion 1 are different. Specifically, the angles between the branch sections and the horizontal trunk portion 1 are gradually increased from the branch section A which is closest to intersected center of the horizontal trunk portion 1 and the vertical trunk portion 2 to the farthest branch section E away the intersected center thereof, wherein the angles are gradually increased from 0° (0° is not included) to 90° (90° is not included).

In a preferred embodiment, the angles between the branch sections and the horizontal trunk portion 1 are gradually increased from 35° to 55°. For example, the angle between the branch section A and the horizontal trunk portion 1 is 35°, and the angle between the branch section B and the horizontal trunk portion 1 is 40°, and the angle between the branch section C and the horizontal trunk portion 1 is 45°, and the angle between the branch section D and the horizontal trunk portion 1 is 50°, and the angle between the branch section E and the horizontal trunk portion 1 is 55°.

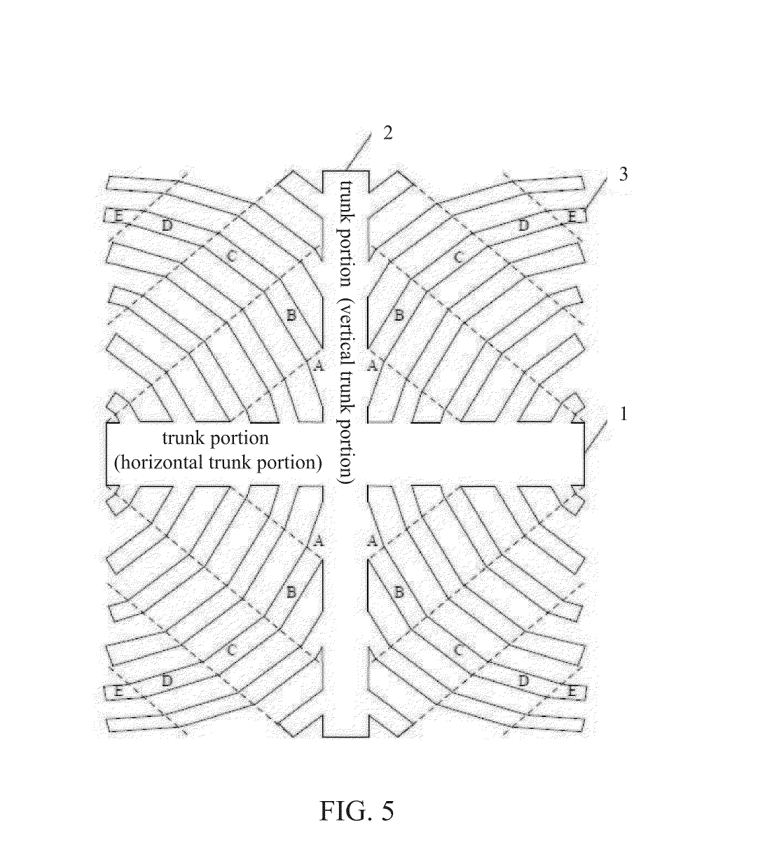

Referring to FIG. 5, FIG. 5 is a structural diagram showing the pixel electrode structure according to a fourth embodiment of the present invention.

In the pixel electrode structure of this embodiment of the present invention, the angles between the branch sections of the bending branch portions 3 and the horizontal trunk portion 1 are gradually decreased from the branch section, which is closest to an intersected center of the horizontal trunk portion 1 and the vertical trunk portion 2, to the farthest branch section away the intersected center thereof.

Specifically, as shown in FIG. 5, the bending branch portions 3 are composed of branch sections A, B, C, D and E. The angles between the plurality of branch sections A, B, C, D and E and the horizontal trunk portion 1 are different. Specifically, the angles between the branch sections and the horizontal trunk portion 1 are gradually increased from the branch section A which is closest to intersected center of the horizontal trunk portion 1 and the vertical trunk portion 2 to the farthest branch section E away the intersected center thereof, wherein the angles are gradually decreased from 90° (90° is not included) to 0° (0° is not included).

In another preferred embodiment, the angles between the branch sections and the horizontal trunk portion 1 are gradually decreased from 55° to 35°. For example, the angle between the branch section A and the horizontal trunk portion 1 is 55°, and the angle between the branch section B and the horizontal trunk portion 1 is 50°, and the angle between the branch section C and the horizontal trunk portion 1 is 45°, and the angle between the branch section D and the horizontal trunk portion 1 is 40°, and the angle between the branch section E and the horizontal trunk portion 1 is 35°.

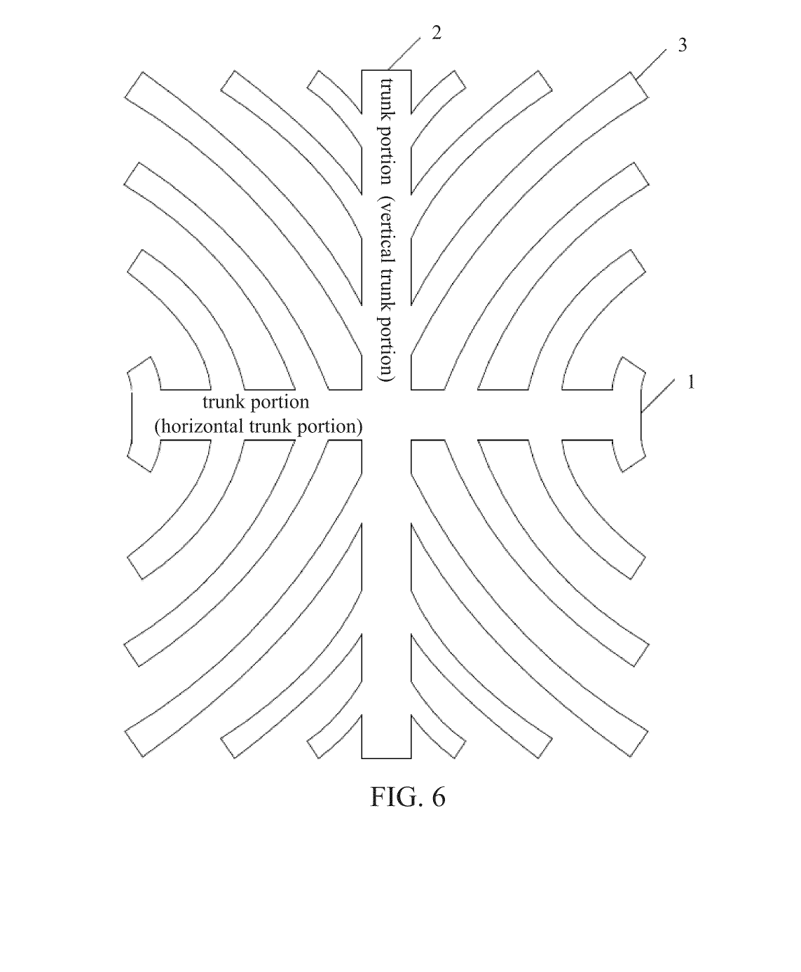

Referring to FIG. 6, FIG. 6 is a structural diagram showing the pixel electrode structure according to a fifth embodiment of the present invention.

In the pixel electrode structure of this embodiment of the present invention, the amount of the branch sections of each of the bending branch portions 3 is infinite, and the angles between the branch sections of the bending branch portions 3 and the horizontal trunk portion 1 are gradually decreased from the branch section, which is closest to an intersected center of the horizontal trunk portion 1 and the vertical trunk portion 2, to the farthest branch section away the intersected center thereof, so as to allow the bending branch portions 3 to form smooth curved structures.

Specifically, as shown in FIG. 6, the bending branch portions 3 of the bending branch portions can be the smooth curved structures which are different to the straight-line shaped structures of the conventional branch portions. Moreover, the angles between tangent lines of the smooth curved structures and the horizontal trunk portion 1 are gradually decreased from a point of the smooth curved structure, which is closest to an intersected center of the horizontal trunk portion 1 and the vertical trunk portion 2, to a farthest point of the smooth curved structure away the intersected center thereof.

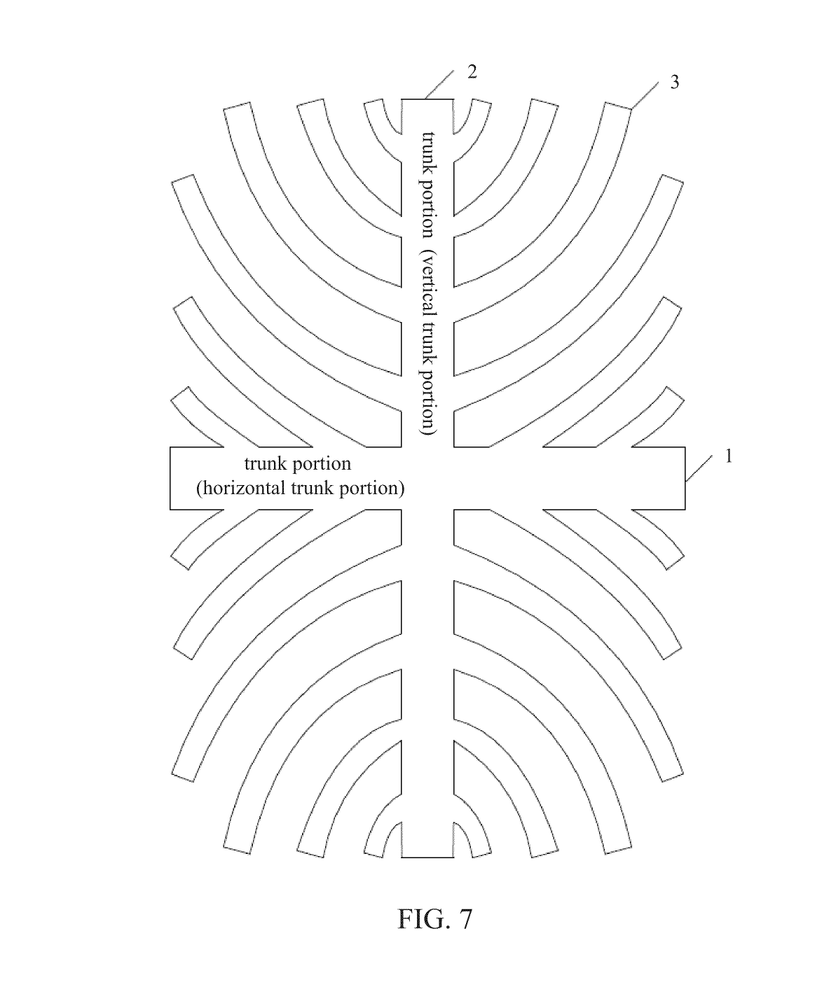

Referring to FIG. 7, FIG. 7 is a structural diagram showing the pixel electrode structure according to a sixth embodiment of the present invention.

In the pixel electrode structure of this embodiment of the present invention, the amount of the branch sections of each of the bending branch portions 3 is infinite, and the angles between the branch sections of the bending branch portions 3 and the horizontal trunk portion 1 are gradually increased from the branch section, which is closest to an intersected center of the horizontal trunk portion 1 and the vertical trunk portion 2, to the farthest branch section away the intersected center thereof, so as to allow the bending branch portions 3 to form smooth curved structures.

Specifically, as shown in FIG. 7, the bending branch portions 3 of the bending branch portions can be the smooth curved structures which are different to the straight-line shaped structures of the conventional branch portions. Moreover, the angles between tangent lines of the smooth curved structures and the horizontal trunk portion 1 are gradually increased from a point of the smooth curved structure, which is closest to an intersected center of the horizontal trunk portion 1 and the vertical trunk portion 2, to a farthest point of the smooth curved structure away the intersected center thereof.

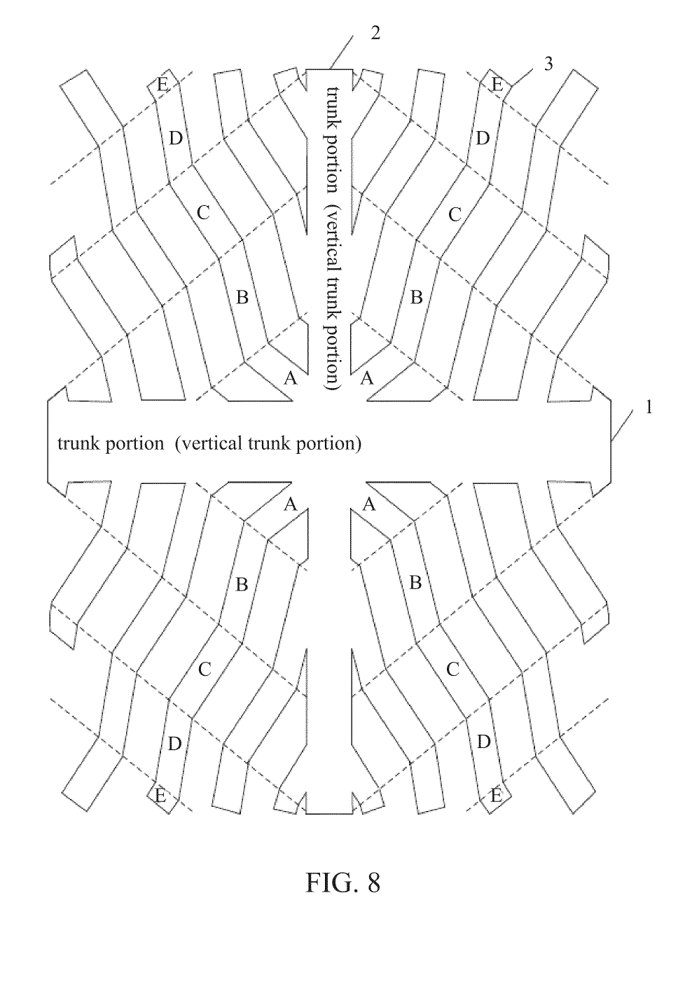

Referring to FIG. 8, FIG. 8 is a structural diagram showing the pixel electrode structure according to a seventh embodiment of the present invention.

In the pixel electrode structure of this embodiment of the present invention, the angles between the branch sections of the bending branch portions 3 and the horizontal trunk portion 1 are alternately increased and decreased from the branch section, which is closest to the intersected center of the horizontal trunk portion 1 and the vertical trunk portion 2, to the farthest branch section away the intersected center thereof.

The bending branch portions 3 of the branch portions can be composed of branch sections A, B, C, D and E. The angles between the branch sections A, B, C, D and E and the horizontal trunk portion 1 are different. Specifically, the angles between the branch sections and the horizontal trunk portion 1 are alternately increased and decreased (neither gradually increased nor gradually decreased) from the branch section A which is closest to intersected center of the horizontal trunk portion 1 and the vertical trunk portion 2 to the farthest branch section E away the intersected center thereof.

In this embodiment, the angle between the branch section A and the horizontal trunk portion 1 is 45°, and the angle between the branch section B and the horizontal trunk portion 1 is 55°, and the angle between the branch section C and the horizontal trunk portion 1 is 45°, and the angle between the branch section D and the horizontal trunk portion 1 is 55°, and the angle between the branch section E and the horizontal trunk portion 1 is 45°.

When the amount of the branch sections of each of the bending branch portions 3 is infinite, the bending branch portions 3 may be smooth wavy structures (not shown).

The pixel electrode structure of the present invention can be applicable to a polymer stabilization vertical-alignment (PSVA) mode LCD panel, a pattern vertical alignment (PVA) mode LCD panel and the like. The material of the pixel electrode in the pixel electrode structure may be ITO, IZO or Amorphous ITO.

The pixel electrode structure of the present invention has a special design which is different to the conventional pixel electrode structure having the constant angles between the branch portions and the horizontal trunk portion, and the branch portions of the present invention are designed as bending branch portions, smooth curves or smooth wavy structures, and the angles between the bending branch portions and the horizontal trunk portion are not only ±45° and ±135°. Each of the bending branch portions of the branch portions is composed of the plurality of branch sections, and the angles between the branch sections and the horizontal trunk portion are different. Thus, by means of the pixel electrode structure of the present invention, the problems of the lower transmittance can be improved, and the LCD panel using the pixel electrode structure can have a higher transmittance for preventing the low transmittance and the color shifting defect.

The present invention has been described with preferred embodiments thereof and it is understood that many changes and modifications to the described embodiments can be carried out without departing from the scope and the spirit of the invention that is intended to be limited only by the appended claims.

1. A pixel electrode structure, characterized in that: the pixel electrode structure comprises:
a trunk portion including a vertical trunk portion and a horizontal trunk portion which are intersected vertically; and
a plurality of branch portions disposed in four sub-pixel regions which are divided by the vertical trunk portion and the horizontal trunk portion, wherein the branch portions in each of the sub-pixel regions include a plurality of bending branch portions, and each of the bending branch portions is composed of a plurality of branch sections, and angles between each adjacent two of the branch sections and the horizontal trunk portion are different, and there are slits between the bending branch portions.

2. The pixel electrode structure according to claim 1, characterized in that: the angles between the branch sections of the bending branch portions and the horizontal trunk portion are gradually increased from the branch section, which is closest to an intersected center of the horizontal trunk portion and the vertical trunk portion, to the farthest branch section away the intersected center thereof.

3. The pixel electrode structure according to claim 2, characterized in that: the angles between the branch sections of the bending branch portions and the horizontal trunk portion are gradually increased from the branch section, which is closest to the intersected center of the horizontal trunk portion and the vertical trunk portion, to the farthest branch section away the intersected center thereof, wherein the angles are gradually increased from 0° to 90°.

4. The pixel electrode structure according to claim 1, characterized in that: the angles between the branch sections of the bending branch portions and the horizontal trunk portion are gradually decreased from the branch section, which is closest to an intersected center of the horizontal trunk portion and the vertical trunk portion, to the farthest branch section away the intersected center thereof.

5. The pixel electrode structure according to claim 4, characterized in that: the angles between the branch sections of the bending branch portions and the horizontal trunk portion are gradually increased from the branch section, which is closest to the intersected center of the horizontal trunk portion and the vertical trunk portion, to the farthest branch section away the intersected center thereof, wherein the angles are gradually increased from 90° to 0°.

6. The pixel electrode structure according to claim 2, characterized in that: the amount of the branch sections of each of the bending branch portions is infinite, and the bending branch portions have smooth curved structures.

7. The pixel electrode structure according to claim 1, characterized in that: the angles between the branch sections of the bending branch portions and the horizontal trunk portion are alternately increased and decreased from the branch section, which is closest to an intersected center of the horizontal trunk portion and the vertical trunk portion, to the farthest branch section away the intersected center thereof.

8. The pixel electrode structure according to claim 7, characterized in that: the amount of the branch sections of each of the bending branch portions is infinite, the bending branch portions have smooth wavy structures.

9. The pixel electrode structure according to claim 1, characterized in that: the pixel electrode structure is applicable to a polymer stabilisation vertical-alignment (PSVA) mode liquid crystal display (LCD) panel or a pattern vertical alignment (PVA) mode LCD panel.

10. The pixel electrode structure according to claim 3, characterized in that: the amount of the branch sections of each of the bending branch portions is infinite, and the bending branch portions have smooth curved structures.

11. The pixel electrode structure according to claim 4, characterized in that: the amount of the branch sections of each of the bending branch portions is infinite, and the bending branch portions have smooth curved structures.

12. The pixel electrode structure according to claim 5, characterized in that: the amount of the branch sections of each of the bending branch portions is infinite, and the bending branch portions have smooth curved structures.
